(19) United States
(12) Patent Application Publication
(10) Pub. No.: US 2014/0278710 A1
(43) Pub. Date: Sep. 18, 2014

(54) COST MODEL GENERATION FOR IT SERVICES

(71) Applicant: KEDAR Integration Services, Inc., Lewisville, TX (US)

(72) Inventors: Charles Williams, Lewisville, TX (US); Caleb Williams, San Marcos, TX (US)

(21) Appl. No.: 14/211,829

(22) Filed: Mar. 14, 2014

Related U.S. Application Data
(60) Provisional application No. 61/792,101, filed on Mar. 15, 2013.

(51) Int. Cl. G06Q 10/06

(52) U.S. Cl. CPC G06Q 10/06315
USPC 705/7.25

(57) ABSTRACT

In various implementations, a cost activity model may be generated based at least partially on information received, such as costs, and a predetermined framework. The cost activity model may be utilized to predict costs due to changes, to determine demand utilization, and/or to reconcile estimated and actual costs, for example.

### CROSS-REFERENCE TO RELATED APPLICATION

This application claims priority to U.S. Provisional Patent Application No. 61/792,101, entitled “COST MODEL GENERATION FOR IT SERVICES” filed on Mar. 15, 2013, which is incorporated by reference herein for all purposes.

### TECHNICAL FIELD

The present disclosure relates to generating a cost model for information technology (IT) services.

### BACKGROUND

Companies often deploy information technology (IT) services across divisions, businesses, and/or projects. However, since IT equipment and/or personnel often serve multiple employees, multiple business purposes, and/or multiple business units, the costs associated with IT services may be difficult to ascertain and/or monitor.

### SUMMARY

A cost activity model may be a model for IT services that includes the relationships between parts of a specific organization (e.g., activities, equipment, personnel) and how the costs are distributed across the various parts of the organization, including the various activities of the organization. The cost activity model may be generated based at least partially on information received about the IT services, such as cost information and/or framework information. The cost activity model may be utilized to allow users to view cost allocation across an organization, predict costs due to changes, to determine demand utilization, and/or to reconcile estimated and actual costs.

In various implementations, cost information may be received. The cost information may be related to user(s), business service(s), technical service(s), and/or cost driver(s). A predetermined framework may be retrieved. A cost activity model may be automatically generated based at least partially on the received cost information and the retrieved framework.

Implementations may include one or more of the following features. Cost information may be received that is related to users, business services, technical services, and cost drivers. In some implementations, at least a first portion of the generated cost activity model may be presented and a request may be received for additional information related to the first portion of the generated cost activity model. A second portion, which includes at least part of the requested additional information related to the presented first portion, of the generated cost activity model may be presented. The generated cost activity model may be stored (e.g., in a memory of the system). In some implementations, the generated cost activity model may be retrieved based on a request from a user. Change(s) to at least a portion of the generated cost activity model may be received and a modified cost activity model may be generated based on one or more of the received changes. In some implementations, the difference(s) between the retrieved cost activity model and the modified cost activity model may be identified. Notification(s) may be generated (e.g., for presentation) based on the identified difference(s) between the retrieved cost activity model and the modified cost activity model. In some implementations, a demand utilization may be determined for one or more portions of the generated cost activity model. In some implementations, a cost estimate may be determined for one or more changes to the generated cost activity model. A report may be generated based on the determined cost estimate. In some implementations, actual costs for one or more of the changes to the generated cost activity model may be received. Difference(s) between the cost estimate and the actual costs may be identified. Notification(s) may be generated based on the identified difference(s).

In various implementations, cost information may be received and a cost activity model may be automatically generated based at least partially on the received cost information and a retrieved framework. The cost information may be related to user(s), business service(s), technical service(s), and/or cost driver(s).

Implementations may include one or more of the following features. The generated cost activity model may stored. In some implementations, at least a first portion of the generated cost activity model may be presented. A request may be received for additional information related to the first portion of the generated cost activity model, and a second portion of the generated cost activity model may be presented. The presented second portion may include at least part of the requested additional information related to the presented first portion. A cost estimate may be determined for change(s) to the generated cost activity model. Actual costs for the changes to the generated cost activity model may be received, and difference(s) between the cost estimate and the actual costs may be identified. In some implementations, a demand utilization for portion(s) of the generated cost activity model may be determined. A graphical user interface may be generated for presenting at least a portion of the determined demand utilization.

In various implementations, a system for analyzing IT services may include a memory and a processor. The memory may store a framework and a modeling module. The processor may be adapted to execute the modeling module to receive cost information, retrieve a stored framework, and automatically generate a cost activity model based at least partially on the received cost information and the retrieved framework. The cost information may be related to user(s), business service(s), technical service(s), and/or cost driver(s).

Implementations may include one or more of the following. The memory may store the generated cost activity model. The modeling module, when executed by the processor, may be further adapted to retrieve the generated cost activity model based on a request from a user; receive change(s) to at least a portion of the retrieved cost activity model; and generate a modified cost activity model based on the received change(s). The modeling module, when executed by the processor, may be further adapted to determine a cost estimate for change(s) to the generated cost activity model; receive actual costs for the change(s) to the generated cost activity model; and identify difference(s) between the cost estimate and the actual costs. The modeling module, when executed by the processor, may be further adapted to generate graphical user interface(s) to receive the cost information from user(s).

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of the present disclosure and its features, reference is now made to the following description, taken in conjunction with the accompanying drawings, in which:

FIG. 1A illustrates an implementation of a system including a modeling system.

FIG. 1B illustrates an implementation of an example flowchart of modeling system.

FIG. 2 illustrates an implementation of an example process for generating a cost activity model.

FIG. 3 illustrates an implementation of an example framework.

FIG. 4 illustrates an implementation of an example process for using a cost activity model.

FIG. 5 illustrates an implementation of an example process for using a cost activity model.

Like reference symbols in the various drawings indicate like elements.

### DETAILED DESCRIPTION

Companies deploy a variety of Information Technology (IT) services to promote business goals, to satisfy daily business needs, produce goods and/or services, manage data and/or costs, etc. Companies may implement a variety of best business practice standards (e.g., Business Process Management (BPM), IT Service Management (ITSM) standards, ITIL (Information Technology Infrastructure Library) standards, ISO standards, industry standards, and/or other criteria in the management and/or implementation of IT services. Due to the nature of IT services (e.g., equipment may be utilized for a variety of business purposes and/or the IT service structure being complex), an accurate analysis of the IT services may be difficult to obtain.

A modeling system may be utilized to generate a cost analysis model of the IT services. A cost activity model may be a model for IT services that includes the relationships between parts of a specific organization (e.g., activities, equipment, personnel) and how the costs are distributed across the various parts including the various activities of the organization. The cost activity model may compile information provided by users about IT services at an organization, such as a company or group, and correlate the compiled information such that costs for various parts (e.g., activites, users, and/or services) may be determined and/or presented to a user.

The cost analysis model may allow costs and/or demand utilization to be identified, costs associated with changes to be predicted, predicted costs and actual costs to be reconciled, etc. By utilizing the modeling system with the IT services of a company, responsibility for costs of various portions of IT services may be accounted, monitored, and/or reconciled with projected budgets. For example, the modeling system may help plan budgets, facilitate in bid requests (e.g., by providing a listing of necessary equipment and/or services required, and/or cost estimates), reconciling budgets and/or actual costs, and/or providing accountability for costs (e.g., based on user, functions, divisions, business services, and/or technical services).

FIG. 1 illustrates an implementation of an example system 100. The system 100 may include a modeling system 110. Users may access the modeling system 110 using user device(s), such as user device A 130 and/or user device B 140, via the Internet 120. Various third party systems 150, such as IT service software (e.g., HP Business Service Automation, commercially available from HP, Palo Alto, Calif.) may be coupled to the modeling system 110 and/or the user devices via the Internet 120.

The modeling system 110 may include a server, for example. The modeling system 110 may be a web-based service and in which access may be provided to users through the Internet 120. The modeling system 110 may include a processor that executes instructions and manipulates data to perform operations of the modeling system 110.

The modeling system 110 may include memory that stores data. For example, data may include best business practices (e.g., BPM, ITSM, and/or ITIL), industry or governmental standards, cost data, estimated cost data, average costs, generated models, frameworks for models, predefined sets and/or lists, reports, data from monitoring various IT service systems, previously generated models, projected budgets for changes, actual costs for changes, reconciliation data including the differences between projected and actual costs, other data described herein, and/or any other data useful to the IT services and/or modeling system.

In addition, various software may be stored on the memory of the modeling system 110. For example, the software may include instructions (e.g., operating systems and/or other types of software) and/or a modeling module. The modeling module may generate interfaces (e.g., graphical user interfaces) to facilitate user interaction, such as prompting a user to provide information and/or receiving information from a user (e.g., to generate a model), retrieving a framework from which to generate a model, generating a framework based on framework information from a user, generating listings of predefined framework information, storing and/or retrieving models, applying changes to models, modifying models, presenting models, generating notifications, determining cost estimates (e.g., per activity and/or per user), generating reports, determining demand utilizations, communicating with other software such as third party software related to IT services (e.g., HP Business Service Automation, commercially available from HP, Palo Alto, Calif.) and/or other appropriate operations. The modeling module may accesses data upon request and/or may facilitate access to various forms of data.

The modeling system 110 may include a communication interface that may allow the modeling system to communicate with other repositories, user devices (e.g., user device A 130 and/or user device B 140), third party systems 150 and/or other computer systems via the Internet 120. The communication interface of the modeling system 110 may transmit data from modeling system and/or received data from other computer systems, such as coupled repositories, user devices and/or third party systems, via any appropriate network protocol (e.g., TCP/IP, Bluetooth, and/or Wi-Fi) and/or a bus (e.g., serial, parallel, USB, and/or FireWire).

In some implementations, additional repositories may be coupled to the modeling system 110 via the Internet. Data useful to the modeling system may be stored in repositories in a plurality of locations such as in a memory of the modeling system 110 and/or in a memory remote to the modeling system. Remote, as used herein, means any component, object, value, variable, and/or data and/or data schema that is not directly processable, accessible, or otherwise capable of communicating with the modeling system. The remote data may be remote to the modeling system 110 but may be local to system 100 or even physically resident on a user device, such as user device A 130, coupled to the system.

User devices, such as user device A 130 and/or user device B 140, may allow a user to access the modeling system 110 and/or modules of the modeling system. The user devices may include a computer system such as a personal computer, a laptop, a personal digital assistant, a smart phone, and/or any computer system appropriate for communicating with the modeling system 110. The user device and the modeling system may have a client/server relationship, where the user device is the client. The user device may include a processor, a memory, a communication interface, and a presentation interface. The processor of the user device may include a programmable logic device, a microprocessor, and/or any other appropriate device for manipulating information in a logical manner and memory of the user device may include any appropriate form(s) of volatile and/or nonvolatile memory, such as a repository. The communication interface of the user device may allow user device to communicate with other computers and/or repositories via the Internet 120. The communication interface may communicate with the modeling system via any appropriate network protocols (e.g., TCP/IP, Wi-Fi, 802.11g, 802.11n, IR or Bluetooth). A presentation interface of the user device may present data on the user device to a user, such as via a monitor and speakers. For example, a graphical user interface (GUI) generated by the modeling module of the modeling system 110 may be displayed on a presentation interface of the user device.

Although FIG. 1 illustrates one specific example of a system that may be used with the disclosure, the system 100 can be implemented using computers other than servers, as well as a server pool. For example, the modeling system 110 may include a general-purpose personal computer (PC) a Macintosh, a workstation, a UNIX-based computer, a server computer, or any other suitable device. According to one implementation, the modeling system 110 may include a web server. The modeling system 110 may be adapted to execute any operating system including UNIX, Linux, Windows, or any other suitable operating system. In short, the modeling system 110 may include software and/or hardware in any combination suitable to provide access to data and/or translate data to an appropriate compatible format.

The modeling system may be accessed by a user to generate a model from which costs may be estimated based on activities and/or parts of the system, from which the impact of changes may be estimated, from which budgets may be reconciled with, and/or from which demand utilization may be obtained, for example. The model generated by the modeling system may allow the provided costs to associated with various portions of a framework, such as a framework that includes guidance from ITIL. For example, FIG. 1A illustrates an example flowchart 150 of how costs may be examined across an example framework. As illustrated, various ITIL processes may be included and incorporated into the framework and generated model. The activity costs in the generated model may be presented according to one or more of the illustrated processes.

FIG. 2 illustrates an implementation of an example process 200 for generating a model. Cost information related to user(s), business service(s), technical service(s), and/or cost driver(s) may be received (operation 210). For example, a user may log into the modeling system through a website and provide cost information related to a company and/or parts thereof. The cost information may include direct costs, such as the cost of equipment, and indirect costs, such as facility costs (e.g., where equipment and/or personnel reside) and/or other overhead costs. Cost information may include information such as unit cost, total cost, and/or other information. For example, cost information may include, but is not limited to:
Cost(s) of the Technology Infrastructure (e.g., item name, description, total cost, unit cost, and/or number of technology components). For example, 150 Microsoft Servers, $50,000 may be provided as cost information.
Activity Tasks, for example, performed in Department(s) (e.g., the number of hours it takes to perform that Activity Task, average hourly rate, representative hourly rate, individual hourly rate). For example, the time (e.g., hourly and/or weekly) commitment for individuals defined in the modeling system under a Labor Aggregation Group (LAG)) may be provided as cost information.
Project cost (e.g., number of hours departmental staff, such as defined in a LAG, will contribute to complete the project and/or other project based expenditures, such as equipment purchases, travel expenses, etc.).
Vendor Costs (e.g., amount billed by vendors). Vendors may include outside organizations the customer has engaged to perform services.
Other costs. For example, the cost of other expense items to be accounted for within the model may be provided as cost information.
Facility information (e.g., name and/or description of physical location/facility where IT assets reside, power costs to maintain assets at the facility, rent, insurance, cost to be apportioned to the IT organization, etc.).
Employee cost information (e.g., title of departmental roles, average hourly rate for individual in the role, average hourly rate for a region, average number of holidays, vacations, and/or other off days for the department); and/or
Relational information. For example, the user may provide relational information to associate cost information with cost drivers, technology services, business services, etc.

The modeling system may generate a graphical user interface through which the cost information may be received. The modeling system may request predetermined information, such as cost information based at least partially on a framework stored in the modeling system.

A cost-activity model may be generated at least partially based on the received cost information and a predetermined framework (operation 220). A cost activity model may identify activities in a company and assign cost(s) of activity resource(s) to all products and services based on the consumption of each activity resource. The cost activity model may allow a user to be presented with cost information based on a unit, such as per user, group of users, activity, business service, and/or technical service. The cost activity model may generate a cost associated with a specific user's consumption of a business service and/or technical service. For example, the cost of providing email to a specified user may be determined based on the generated cost activity model. As another example, the cost of the activity/business service of providing email to the company may be determined based on the generated cost activity model. The model may allow users to drill down (e.g., move between less detailed and more detailed information) into the cost information in the generated model. The modeling system may utilize a graphical user interface to facilitate presentation and modification of information (e.g., when drilling down into data) presented to the user.

Process 200 may be implemented by various systems, such as system 100. In addition, various operations may be added, deleted, and/or modified. For example, the cost activity model may be stored. The cost activity model may be presented to a user. In some implementations, at least a portion of the cost information may be received from third party systems. For example, third party systems may include software, such as accounting software and/or IT asset management software, and may track at least a portion of the cost information (e.g., costs associated with equipment and/or personnel). A user may provide information to allow the modeling system to access cost information stored in third party systems. The modeling system may determine additional cost information to be provided by the user based on a comparison of cost information to be provided for generation of the model and cost information received from the third party systems.

In some implementations, the cost information may include direct costs (e.g., cost of equipment, cost of personnel, etc.) and/or indirect costs, such as facility costs (e.g., where equipment and/or personnel reside and how much the facility costs, such as power costs, rent, insurance, etc.).

In some implementations, the modeling system may utilize the provided cost information and the generated cost activity model to determine a capacity for parts of the company. For example, a capacity for each worker in the IT department and/or the IT department may be determined. The capacity of the worker may be utilized in determining demand utilization in the model generated by the modeling system.

In some implementations, the modeling system may generate the cost activity model based on the provided cost information, framework, and/or framework information. The cost activity model may generate one or more reports and/or interfaces to present information, such as unit costs, overall costs, etc.

In some implementations, the modeling system may a framework, and the provided cost information may be utilized with the framework to generate the model. For example, the framework may provide a structure (e.g., related nodes) into which the cost information that is associated with a company may be provided. In some implementations, the modeling system may provide a preset framework and the user may provide modifications to the framework (e.g., specific to the company being modeled).

The framework may be a structure that includes the identity and relationships between various parts of a company. The framework may be a tree structure or non-tree structure, in some implementations. Framework information, such as number of nodes, identity of nodes (e.g., users, business services, technical services, and/or cost drivers), relationship between nodes, etc., may be received by the modeling system from a user. The framework may be based on best practices, such as, but not limited to:
IT Infrastructure Library (ITIL), an international set of documented standards controlled by a governing body that provide best practice and IT management concepts of a comprehensive, process-oriented framework for the management of IT services.
IT Service Management (ITSM), a philosophical approach to IT management that focuses on the end-user (customer) viewpoint. ITSM has no governing body, but it shares nomenclature and terminology with parts of the ITIL framework. ITSM has the relevance in setting service level agreements and determining budget, staffing, and/or operating priorities in the context of the business community needs.
ISO 20000, an international set of standards for IT management processes controlled by the International Standards Organization (ISO), which promotes and certifies IT organizations based on their demonstrated ability to comply with these standards in meeting a integrated approach to delivery managed services to the business community.
COBIT (Control Objectives for Information and Related Technology), which provides a framework for ensuring the best use of IT in an organization as well as guidelines for compliance with best practices for IT processes and controls. Some versions also share terminology and concepts with parts of the ITIL framework.
EA (Enterprise Architecture), which provides a framework approach to develop an IT architecture that defines business processes that need to be supported by enterprise systems, and categorizing and aligning them appropriately. and/or
Other best practices and methods from accepted industry disciplines, such as total cost of ownership; Activity Based Costing (ABC); and/or managerial cost accounting.

FIG. 3 illustrates an implementation of an example framework 300. As illustrated, the framework includes a plurality of related nodes (e.g., users, business services, technical services, and/or cost drivers). In some implementations, the framework may include one or more preset relationships between at least portions of the nodes. The preset relationships may be confirmed by the user (e.g., through an interface of the modeling system), altered by the user, and/or deleted by the user. In some implementations, the identity of one or more of the nodes may be provided in the framework. The user may confirm and/or alter the identity of the node and/or delete the node. In some implementations, the user may be prompted to select a node identity and/or prompted by the modeling system to provide specific information related to the node, such as cost information and/or relational information (e.g., between the node and one or more other nodes).

The framework, as illustrated in FIG. 3, includes one or more nodes that identify users 310, such as user A 312 and user B 314; business services 320, such as business service A 322 and business service B 324; technical services 330, such as technical service A 332, technical service B 324, and technical service C 326; and cost drivers 340, such as cost driver A 342, cost driver B 344, cost driver C 346, and cost driver D 348. The relationship between the nodes is illustrated in FIG. 3 by lines connecting the related nodes. Although the user node is described as a user, in some implementations, the user may include a group of users.

The identity of nodes in the framework may be at least partially based on standards, such as ITIL. For example, the modeling system may generate a listing based on ITIL processes and a user may select nodes from the listing. A user may select from a listing of potential business services, cost drivers, and/or components thereof.

As illustrated, the framework may also include nodes for one or more business services employed by a company. Business services may include services provided by IT services that are recognizable for users. For example, business services may include, but are not limited to:

Email,

Business Administration

Project Management

Business Application Services

Technology Education & Training

Network Services

Server Administration

Storage Systems Administration

Database Services

Mainframe Hosting Services

Distributed Hosting Services

Service Desk

Desktop Services

Enterprise Support Services

Directory Access Management

Messaging Communications

Radio Communications

Telephone Services

Audio/Video Services

IT Security Services

Backup & Recovery Services; and/or

Disaster Recovery Services

As illustrated, the framework may include nodes for technical services for a company. The technical services may include activities that are used to provide business services. As illustrated, a specific technical service, such as technical service A, may be utilized by more than one business service and thus, more than one user. Technical services, may include, but are not limited to:

Business Administration

Project Management

Business Application Services

Technology Education & Training

Network Operations

Network Planning & Engineering

Email

Server Administration

Server Administration

Storage Systems Administration

Database Services

Mainframe Hosting Services

Distributed Hosting Services

Data Center Services

Service Desk

Desktop Services

Enterprise Support Services

SAP Basis

IT Service management

Directory Access Management

Messaging Communications

Radio Communications

Telephone Services

Audio/Video Services

IT Security Services

Backup & Recovery Services; and/or

Disaster Recovery Services

The framework may include one or more nodes representing cost drivers. The cost drives may include units of activities that have costs. The units may be based on Activity Base Cost methodologies, which identify activities in a company. For example, cost drivers may include technology components, projects, vendors, activities and/or other costs.

The framework may include a relationship between the various nodes in the framework. The relationship between the nodes may be utilized by the modeling system to assign cost information (e.g., fractionally and/or weighted) provided by a user. In some implementations, a user may provide weighting information. The weighting information may indicate what percentages of costs of a node are apportioned to and/or from related nodes. For example, cost driver C 346 may be utilized by Technical service B 334 and Technical service C 336. A user may provide weighting information that indicates that cost information from cost driver C 346 is apportioned 30% to Technical service B 334 and/or 70% to Technical service C 336. When the cost-activity model is generated, the weighting information may be included such that costs per activity may be based at least partially on the weighting information (e.g., the cost of Technical service B 334 includes 30% of cost driver C in a resulting model).

In some implementations, the modeling system may retrieve a first framework, receive one or more or no modifications from a user, and generate a second framework. The modeling system may then request cost information from the user based at least partially on the second framework. For example, the modeling system may include a set of types of cost information and request cost information based on the framework and the types of cost information associated with aspects of the framework from the set. For example, types of cost information may include name, cost, license fee, hours worked/attributed to item, pay rate (e.g., hourly, average for a group, individually, typical industry pay rate, etc.). The cost information may include cost information related to IT department(s) that support cost drivers, such as projects and activates (e.g., days/week utilized, hours/day utilized, cost of benefits, average vacation time, average sick time, average other time off, and/or other information related to costs in an IT department.

In some implementations, the framework may include rigidity or portions in which modification is inhibited. For example, the framework may restrict customization of various portions. When a user indicates that a particular cost driver is present, the modeling system may inhibit a user from customizing the framework to skip a subset of cost information requested by the modeling system. In some implementations, the framework restrictions may be based on ITIL and/or other business practices. For example, the predefined framework may restrict modification of the types of cost drivers and the modeling system may request cost information for each type of cost driver in the framework (e.g., the user may be restricted from modifying the framework to eliminate a specific cost driver once a specific activity, such as a technical service is selected). A framework that includes at least some restrictions may reduce errors in the cost activity model, such as user error that arises when a user skips modeling system requests for information.

In some implementations, the framework may include preset cost information. For example, average costs (e.g., across a region and/or industry) associated with various activities may be stored in a memory of the modeling system and a user may select to utilize a preset cost. The preset cost information may be provided and/or presented to a user, in some implementations, to notify the user in differences between the cost information provided by a user and preset costs. The notification may alert the user to errors in entry (e.g., when the cost is 20% higher than the preset cost) and/or high component costs for a company.

In some implementations, a user may log into an interface of the modeling system to generate a cost activity model for an organization. The modeling system may receive the request to generate a model and generate one or more interfaces to facilitate the receipt of information, such as cost information, framework customization, and/or framework information. For example, a user may provide framework information for a predefined framework, a customized framework, and/or a partially customized framework including, but not limited to:
Business and/or Technical Service names
Business and/or Technical Services descriptions
Process Activities names and/or descriptions
Business Community entities (e.g., that the IT organization supports) name and/or description
IT organization department name and/or description (e.g., the title of the Manager and/or a description of the department); and/or
Relation information (e.g., how provided information or nodes perform IT tasks and have varying technologies aligned to deliver each Business Community entity technology based services).

The framework information provided by the user to the modeling system may be selected from predefined lists generated and/or retrieved by the modeling system. The modeling system may allow users to customize items selected from the predefined lists and/or provide custom (e.g., free form) framework information.

The framework information provided by the user may be utilized to populate the nodes and/or relationships between the nodes in the framework (e.g., predefined and/or custom framework). The modeling system may transmit a request to the user if additional information is needed to populate the framework.

FIG. 4 illustrates an implementation of an example process 400 for using a generated model. A cost activity model generated based on received cost information may be retrieved (operation 410). For example, a cost activity model may be retrieved from a memory coupled to the modeling system (e.g., local or remote). The cost activity model may be based on information previously provided by the same user or a different user.

One or more changes to a cost activity model may be received (operation 420). In some implementations, the user may alter a part of the model and/or a cost in the model. For example, a change may include outsourcing an activity (e.g. a business service and/or technical service). When an activity is outsourced, the use of various parts of the model (e.g., users, business services, technical services, and/or cost drivers) may be modified and/or deleted. The user may provide cost information based on the change (e.g., cost charged by a vendor to outsource). As another example, the change may include hiring 100 people. Since the retrieved model includes costs per unit such as per employee, per task of an employee, etc., the cost for hiring a new employee may be determined. By utilizing the unit costs in the retrieved model, a more accurate estimate (e.g., when compared to estimates based on memory or past hiring costs) of a cost may be determined (e.g., since costs are automatically accounted for in unit costs).

A modified cost activity model may be generated based on the received change(s) (operation 430). The modeling system may receive the provided change from the user and alter the model based on the provided change. For example, if new employees are to be hired in a division, the cost per employee (e.g., average, average for an employee level, etc.) may be determined based on the retrieved model and may be associated with the new employee(s). As another example, if the change was to outsource an activity, such as email, then the modeling system may delete portions of the model assigned to the activity (e.g., portion of technical services and/or cost drivers attributed to the specific activity) and add the outsourcing activity and/or cost information related to the outsourcing activity.

A modified cost activity model may be presented (operation 440). The user may be presented with the modified cost activity model through one or more interfaces generated by the modeling system. The user may drill down though data in the modified cost activity and/or view various portions of the modified cost activity model. The modeling system may determine the cost associated with the change provided by the user based at least partially on the retrieved model and the modified model. The cost associated with the change may be presented to the user and/or the user may be able to drill down through the cost to determine where the costs originate.

One or more notifications may be generated (e.g., to be presented to a user) based on the difference(s) between the retrieved cost activity model and the modified cost activity model (operation 450). For example, changes may be flagged, highlighted, or otherwise indicated. The notifications may be presented on a dashboard view (e.g., summary) or in graphical user interfaces proximate the changes (e.g., when users view portions of the generated model, such as when drilling down through the model to view the data in the modified model).

Process 400 may be implemented by various systems, such as system 100. One or more operations of process 400 may be modified to include one or more operations of other described processes, such as those described in process 200. In addition, various operations may be added, deleted, and/or modified. For example, differences between the retrieved model and the modified model may not be generated by the system. In some implementations, the modeling system may include preset changes and/or cost information, as appropriate, for the changes. The user may select a preset change (e.g., fire 200 employees, outsource IT department help desk, update specific software). If the cost is not a cost that the model can determine (e.g., outsourcing costs, costs associated with changing vendors, etc.), a model may request cost information related to the change requested and/or present a user with a predetermined cost estimate for the change (e.g., average cost in an industry).

FIG. 5 illustrates an implementation of an example process 500 for utilizing a cost activity model. A cost activity model based on received cost information may be retrieved (operation 510). For example, the cost activity model may be stored in a memory of a user device and when the user logs into a website generated by the modeling system, the generated cost activity model may be retrieved.

A demand utilization for one or more parts of the cost activity model may be determined (operation 520). The demand utilization may be based at least partially on economic and accounting methods to determine the potential capacity of a unit (e.g., person, equipment, facility) and the extent to which the unit is utilized in the current model. For example, a demand utilization may be determined for an employee from the allocations in the retrieved model. For example, if, based on the model, the employee is allocated to provide 20 hours a week to support technical service A, 10 hours a week to support technical service B, and has 2 hours a week off, then the demand utilization may be determined and indicate that the employee has 8 hours a week of potential capacity. The model may determine the costs associated with the employee and determine the cost to the company for the underutilization of the employee. As another example, a demand utilization for a server may be determined. For example, a server may be allocated 50% to technical service B and 49% to technical service C, in the retrieved model. The modeling system may determine the demand utilization for the server based on the allocation and/or other factors (e.g., such as minimizing potential slowdowns andor overuse) and determine that the server is operating at full capacity because the modeling system may determine that servers allocated above 98% are operating at full capacity.

A cost estimate for change(s) to the cost activity model may be determined (operation 530). For example, since the retrieved model and the generated model include unit cost information (e.g., cost per user(s), business service(s), and/or technical service(s)), the unit cost information may be utilized to determine the cost of a change. For example, since costs per employee are identified in the model, the cost of adding employees may be determined by multiplying the cost per employee by the number of new employees. As another example, the cost of providing disaster recovery per user may be included and/or generated by in the generated model. Thus, when a new employee is hired or fired the cost directly attributable to the employee for disaster recovery may be quantified. Since the unit costs include costs often overlooked (e.g., software costs, benefits costs, need for new servers, need for additional IT help desk workers, facility costs, and/or increased backup storage) a more accurate estimate of the cost of a change may be determined based on the model.

A report based on the cost estimate for the change(s) may be generated (operation 540). The report may include portions of the model, changes made, overall costs, costs of specific parts, etc. In some implementations, the report generated may include bid information (e.g., information that may be include in a bid for services request). For example, when a technical service is being outsourced, the components utilized in the retrieved model and replaced and/or deleted in the modified model may be listed. A company may utilize the list to set minimum standards for a bid request (e.g., since the company may like to maintain the same operations and/or capacities when the technical service is outsourced).

An actual cost for the change(s) may be determined (operation 550). For example, a company may implement a change included the modified model and determine the cost associated with making the change in the company. The modeling system may receive the actual costs from the user and/or third party systems.

One or more differences between the cost estimate and the actual cost for at least a portion of the change(s) to the cost activity model may be identified (operation 560). For example, overall cost and/or portions thereof may be determined by comparing one or more costs in the modified model (e.g., projected cost) and one or more associated actual costs (e.g., same type, replaced item costs). The differences may allow reconciliation of estimates and actual costs. Allowing reconciliation of budget estimates and actual costs may provide companies with greater accountability of costs. In some implementations, since the costs and differences between projections and actual costs may be identified for specific parts of the system, such as in activities and per user, the portions of the system in which the costs were different may be pinpointed with greater accuracy than overall costs. Allowing specific identification of discrepancies between projected budgets (e.g. estimates based on the generated model) and actual costs may provide greater accountability for costs for a company.

One or more notification may be generated based on the identified difference(s) (operation 570). Notifications may include flags, pop-up windows, highlighting, shading, etc. For example, when one or more costs in the modified are greater than an actual cost and/or greater than a predetermined allowance percentage (e.g., 5%) a notification may be generated based on the difference. The predetermined allowance percentage may be stored in a memory of the modeling system and retrieved to determine whether a notification should be generated. The predetermined allowance percentage may be set by a user or by the modeling system.

Process 500 may be implemented by various systems, such as system 100. One or more operations of process 500 may be modified to include one or more operations of other described processes, such as those described in processes 200 and/or 400. In addition, various operations may be added, deleted, and/or modified. For example, demand utilization may not be determined. As another example, a user may be presented with a predetermined listing of changes to the retrieved model. For example, an interface may include sliding bars to scale up or scale down various portions of the model (e.g., number of employees). In some implementations, a drop down listing of changes may be generated in the interface and a user may select from among the changes in the listing.

Although in various implementations the generated model has been described as modeling a company, the generated model may describe any other appropriate entity with IT services, such as business units, regions, and/or technology groups.

Although users have been described as a human, a user may be a person, a group of people, a person or persons interacting with one or more computers, and/or a computer system.

Systems that include computers, such as the modeling system user devices, and/or third parties, have been described in various implementations. The computer may include a processor that retrieves instructions, executes instructions (e.g., one or more modules), and/or manipulates data to perform operations of the computer. For example, a processor of the system may retrieve a modeling module, which when executed may perform one or more of the described operations, combinations of the described operations, and/or portions thereof. The processor may execute the modeling module to perform operations, such as receiving cost information, retrieving stored frameworks, automatically generating cost activity model(s) and/or modified cost activity model(s), receive information (e.g., information, for example, from users, such as changes and/or actual costs), determine cost estimates using cost activity model(s), identify differences, transmit notifications, present information and/or cost activity models, allow users to manipulate retrieved and/or generated models, and/or any other appropriate operation. The processor may include a programmable logic device, a microprocessor, or any other appropriate device for manipulating information in a logical manner and memory may include any appropriate form(s) of volatile and/or nonvolatile memory, such as RAM and/or Flash memory.

The memory may include data, such as predetermined frameworks, preset options, customization options, average costs, and/or any other appropriate information. In addition, various software may be stored on the memory. For example, instructions, such as operating systems and/or other types of software (e.g., modeling module) may be stored on the memory. The modules (e.g., modeling module and/or other modules) may perform various operations, such as the operations in the described systems and processes.

In some implementations, modeling module and/or other modules may be combined as a single module or may be distinct modules. Modules may include various modules and/or sub-modules.

A communication interface may allow the computer to communicate with other components of the system, other repositories, and/or other computer systems. The communication interface may transmit data from the computer and/or receive data from other components, other repositories, and/or other computer systems via network protocols (e.g., TCP/IP, Bluetooth, and/or Wi-Fi) and/or a bus (e.g., serial, parallel, USB, and/or FireWire). Operations of the described system stored in the memory may be updated and/or altered through the communication via network protocols (e.g., remotely through a firmware update and/or by a device directly coupled to the computer).

The computer may include a presentation interface to present data to a user, such as though a monitor and speakers. The presentation interface may facilitate receipt of selections from users.

Although examples computers that may be used with the disclosure have been described, the described systems and processes may be implemented through various computers such as servers, as well as a server pool. For example, the modeling system may include a general-purpose personal computer (PC) a Macintosh, a workstation, a UNIX-based computer, a server computer, or any other suitable device. The computer may be adapted to execute any operating system including UNIX, Linux, Windows, or any other suitable operating system. The computer may include software and/or hardware in any combination suitable to provide access to data and/or translate data to an appropriate compatible format.

Although a single processor has been described, multiple processors may be used according to particular needs, and reference to processor is meant to include multiple processors where appropriate.

A memory of the computer may include any appropriate memory including a variety of repositories, such as, SQL databases, relational databases, object oriented databases, distributed databases, XML databases, and/or web server repositories. Furthermore, memory may include one or more forms of memory such as volatile memory (e.g., RAM) or nonvolatile memory, such as read-only memory (ROM), optical memory (e.g., CD, DVD, or LD), magnetic memory (e.g., hard disk drives, floppy disk drives), NAND flash memory, NOR flash memory, electrically-erasable, programmable read-only memory (EEPROM), Ferroelectric random-access memory (FeRAM), magnetoresistive random-access memory (MRAM), non-volatile random-access memory (NVRAM), non-volatile static random-access memory (nvSRAM), and/or phase-change memory (PRAM).

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable signal(s) may be non-transitory waves and/or non-transitory signals.

To provide for interaction with a User, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackpad) by which the user can provide input to the computer. Other kinds of devices can be used to provide for interaction with a user as well; for example, feedback provided to the user by an output device can be any form of sensory feedback (e.g., visual feedback, auditory feedback, or tactile feedback); and input from the user can be received in any form, including acoustic, speech, or tactile input.

A graphical User interface (GUI) of the interface(s) generated by the system may be displayed on a presentation interface of the user device, such as a monitor or screen. GUI may be operable to allow the user of a user device to interact with repositories and/or various interface(s). Generally, GUI provides a user with an efficient and User-friendly presentation of data provided by the system. GUI includes a plurality of displays having interactive fields, such as image icons, pull-down lists, fillable fields, and editable text operated by the user. And in one example, GUI presents an explore-type interface and receives commands from the user. It should be understood that the term graphical user interface may be used in the singular or in the plural to describe one or more graphical User interfaces in each of the displays of a particular graphical User interface. Further, GUI contemplates any graphical user interface, such as a generic web browser, that processes information in the system and/or user device and efficiently presents the information to the user. In some implementations, GUI may present a web page embedding content. The server can accept data from a User device(s) via the web browser (e.g., Microsoft Internet Explorer or Netscape Navigator) and return the appropriate Hyper Text Markup Language (HTML) or eXtensible Markup Language (XML) responses.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a type node” includes a combination of two or more types of nodes and reference to “cost information” includes different types and/or combinations of cost information. As another example, “coupling” includes direct and/or indirect coupling of members (e.g., users, modeling system, third party systems, and/or other systems).

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular implementations of the process, machine, manufacture, composition of matter, means, methods and operations described in the specification. As one of ordinary skill in the art will readily appreciate from the disclosure, processes, machines, manufacture, compositions of matter, means, methods, or operations, presently existing or later to be developed that perform substantially the same function or achieve substantially the same result as the corresponding implementations described herein may be utilized according to the present disclosure. Accordingly, the appended claims are intended to include within their scope such processes, machines, manufacture, compositions of matter, means, methods, or operations.

1. A computer implemented method for analyzing IT services, the method comprising:
receiving cost information comprising cost information related to at least one of:
one or more users;
one or more business services;
one or more technical services; or
one or more cost drivers;
retrieving a predetermined framework; and
automatically generating a cost activity model based at least partially on the received cost information and the retrieved framework.

2. The method of claim 1, further comprising:
receiving cost information comprising cost information related to one or more users, one or more business services, one or more technical services, and one or more cost drivers.

3. The method of claim 1, further comprising:
presenting at least a first portion of the generated cost activity model;
receiving a request for additional information related to the presented first portion of the generated cost activity model; and
presenting a second portion of the generated cost activity model, wherein the second portion includes at least part of the requested additional information related to the presented first portion of the generated cost activity model.

4. The method of claim 1, further comprising:
storing the generated cost activity model.

5. The method of claim 1, further comprising:
retrieving the generated cost activity model based on a request from a user;
receiving one or more changes to at least a portion of the generated cost activity model; and
generating a modified cost activity model based on one or more of the received changes.

6. The method of claim 5, further comprising:
identifying one or more differences between the retrieved cost activity model and the modified cost activity model; and
generating one or more notifications, to be presented, based on one or more of the identified differences between the retrieved cost activity model and the modified cost activity model.

7. The method of claim 1, further comprising:
determining a demand utilization for one or more portions of the generated cost activity model.

8. The method of claim 1, further comprising:
determining a cost estimate for one or more changes to the generated cost activity model; and
generating a report based on the determined cost estimate.

9. The method of claim 1, further comprising:
determining a cost estimate for one or more changes to the generated cost activity model;
receiving actual costs for one or more of the changes to the generated cost activity model; and
identifying one or more differences between the cost estimate and the actual costs.

10. The method of claim 9, further comprising:
generating one or more notifications based on one or more of the identified differences.

11. An article comprising non-transitory, machine-readable medium storing instructions for analyzing IT services, the instructions operable to cause data processing apparatus to perform operations comprising:
receiving cost information comprising cost information related to at least one of:
one or more users;
one or more business services;
one or more technical services; or
one or more cost drivers; and
automatically generating a cost activity model based at least partially on the received cost information and a retrieved framework.

12. The article of claim 11, wherein the instructions are further operable to cause data processing apparatus to perform operations comprising:
storing the automatically generated cost activity model.

13. The article of claim 11, wherein the instructions are further operable to cause data processing apparatus to perform operations comprising:
presenting at least a first portion of the generated cost activity model;
receiving a request for additional information related to the presented first portion of the generated cost activity model; and
presenting a second portion of the generated cost activity model, wherein the second portion includes at least part of the requested additional information related to the presented first portion of the generated cost activity model.

14. The article of claim 11, wherein the instructions are further operable to cause data processing apparatus to perform operations comprising:
determining a cost estimate for one or more changes to the generated cost activity model;
receiving actual costs for one or more of the changes to the generated cost activity model; and
identifying one or more differences between the cost estimate and the actual costs.

15. The article of claim 11, wherein the instructions are further operable to cause data processing apparatus to perform operations comprising:
determining a demand utilization for one or more portions of the generated cost activity model; and
generating a graphical user interface for presenting at least a portion of the determined demand utilization.

16. A system for analyzing IT services, the system comprising:
a memory storing a framework and a modeling module; and
a processor adapted to execute the modeling module to:
receive cost information comprising cost information related to at least one of:
one or more users;
one or more business services;
one or more technical services; or
one or more cost drivers;
retrieve a stored framework; and
automatically generate a cost activity model based at least partially on the received cost information and the retrieved framework.

17. The system of claim 16, wherein the memory stores the generated cost activity model.

18. The system of claim 16, wherein the modeling module is further adapted to:
retrieve the generated cost activity model based on a request from a user;
receive one or more changes to at least a portion of the retrieved cost activity model; and
generate a modified cost activity model based on one or more of the received changes.

19. The system of claim 16, wherein the modeling module is further adapted to:
determine a cost estimate for one or more changes to the generated cost activity model;
receive actual costs for one or more of the changes to the generated cost activity model; and
identify one or more differences between the cost estimate and the actual costs.

20. The system of claim 16, wherein the modeling module is further adapted to:
generate one or more graphical user interfaces to receive the cost information from one or more of the users.
